(19) United States
(12) Patent Application Publication
(10) Pub. No.: US 2009/0125830 A1
(43) Pub. Date: May 14, 2009

(54) Compound Fields

(75) Inventors: Steven Marcek, Mountain View, CA (US); John Lorin Welshofer, Sunnyvale, CA (US); Geoff Schuller, San Jose, CA (US); Brian Barrick, Foster City, CA (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 11/939,525

(22) Filed: Nov. 13, 2007

(51) Int. Cl. G06F 3/048

(52) U.S. Cl. 715/771

(57) ABSTRACT

A compound field is automatically created in response to a trigger event. In one aspect, a user selects a field type and a compound field associated with the field type is automatically created. A compound field can be manipulated and presented as a single conceptual unit in a user interface (e.g., a form, screen or layout) of an application (e.g., a database application). When an object representing the compound field is dragged and dropped or otherwise selected in the user interface, the compound field is expanded to reveal one or more subfields capable of receiving data from a user. In another aspect, one or more background tables are automatically and transparently created to store compound field objects. In another aspect, a user can create their own compound field types.

### TECHNICAL FIELD

The subject matter of this patent application is generally related to database applications.

### BACKGROUND

Many database applications allow users to create single fields one at a time. This can be tedious for a set of fields that are commonly used together (e.g., a street address).

### SUMMARY

A compound field is automatically created in response to a trigger event. In one aspect, a user selects a field type and a compound field associated with the field type is automatically created. A compound field can be manipulated and presented as a single conceptual unit in a user interface (e.g., a form, screen or layout) of an application (e.g., a database application). When an object representing the compound field is dragged and dropped or otherwise selected in the user interface, the compound field is expanded to reveal one or more subfields capable of receiving data from a user. In another aspect, one or more background tables are automatically and transparently created to store compound field objects. In another aspect, a user can create their own compound field types.

Other implementations are disclosed which are directed to systems, methods, and computer-readable mediums.

### DESCRIPTION OF DRAWINGS

FIG. 1 is a screenshot of an example implementation of a graphical user interface for creating a database table through template selection.

FIG. 2 is a screenshot of an example implementation of a graphical user interface for creating a field within a database table.

FIG. 3 is a screenshot of an example implementation of a graphical user interface for creating a compound field within a database table.

FIG. 4 is a screenshot of an example implementation of a graphical user interface for creating an additional compound field of the same type within a database table.

FIG. 5 is a screenshot of an example implementation of a graphical user interface for adding fields to a data entry form.

FIG. 6 is a screenshot of an example implementation of a graphical user interface displaying a data entry form populated with fields.

FIG. 7 is a flow diagram of an example process for creating and using a compound field.

FIGS. 8A-8C illustrate generating associations between records within database tables.

FIG. 9 is a screenshot of an example implementation of a graphical user interface displaying a data entry form populated with fields.

FIG. 10 is a block diagram of an example system architecture for performing the operations described in reference to FIGS. 1-10.

FIG. 11 is a screenshot of an example implementation of a graphical user interface for modifying field types within a database application.

FIG. 12 is a screenshot of an example implementation of a graphical user interface for modifying field types within a database application.

FIG. 13 is a screenshot of an example implementation of a graphical user interface for creating a custom compound field type within a database application.

FIG. 14 is a screenshot of an example implementation of a graphical user interface for saving a custom compound field type within a database application.

FIG. 15 is a screenshot of an example implementation of a graphical user interface for editing a custom compound field type within a database application.

FIG. 16 is a screenshot of an example implementation of a graphical user interface for saving a custom compound field type within a database application.

FIG. 17 is a screenshot of an example implementation of a graphical user interface for modifying a compound field type within a database application.

FIG. 18 is a screenshot of an example implementation of a graphical user interface for saving a modified compound field type within a database application.

### DETAILED DESCRIPTION

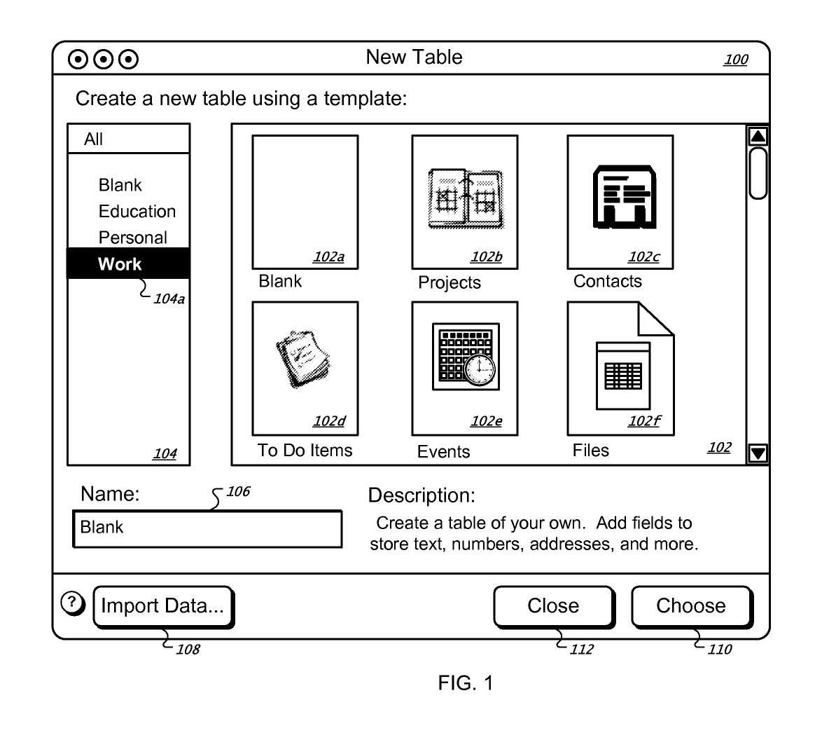

FIG. 1 is a screenshot 100 of an implementation of a graphical user interface (GUI) for creating a database table through template selection. The screen shot 100, for example, can be part of a database software application. A database table has a set of fields which can be populated with information. For example, a contacts table contains information regarding social contacts. The fields within a contacts table can include, for example, first name, last name, phone number, e-mail address, etc. Fields can store any type of information, including, but not limited to, text, numbers, monetary values, dates, descriptions, and identification keys. For example, a field can be defined as containing a 5-digit numeric value, a 15-character alphanumeric value, etc.

In addition to individual fields, a contact table can include one or more compound fields. A compound field relates a set of associated fields into a single field definition. Operations typically performed upon individual fields, including, but not limited to, selection, population, presentation, and report generation, can also be performed upon a compound field. For example, the compound field “address” contains the individual fields representing street address, city, state, zip code, and country. A user can add the compound field “address” to a table and be presented with all of the fields associated with the compound field “address” when populating the compound field with information. Address is only one example of a compound field. Other types (e.g., person, employee, patient, etc.) could easily be created.

A set of user-selectable table templates 102 can allow the user to create a table which is already populated with commonly used single and/or compound fields associated with different applications. For example, the fields populating a contacts table can include first name and last name (both single fields), plus home address and work address (both compound fields). Selection from a list of application types 104 can provide the user with the ability to narrow the range of the table templates 102. In the example shown, selection of an application type “Work” 104a can provide a user with the options of a “Projects” template 102b, a “Contacts” template 102c, a “To do items” template 102d, an “Events” template 102e and a “Files” template 102f. In addition to pre-populated templates, the user can select a blank template 102a to completely customize a database table by populating the table with user-created fields.

Once a template has been selected, a name dialog box 106 provides the user with the ability to name the new table. In some implementations, the template name is automatically inserted within the dialog box 106 as a default value. For example, selection of the blank template 102a populates the dialog box 106 with the name “Blank”.

An import data button 108, if selected, can provide the user with the ability to automatically populate the selected table with stored field values. The imported data, for example, could be imported from any file format (e.g., text document, spreadsheet, Structured Query Language (SQL) database, etc.). In some implementations, imported data can automatically populate the subfields in one or more compound fields where applicable. For example, if the user imports a spreadsheet of contact information, the individual fields that make up an entire address can be imported into the subfields that are within a compound address field. The user can select a choose button 110 to save the new table template which the user has selected and optionally populated with imported data. A close button 112 can instead be selected to exit the GUI without creating a new table.

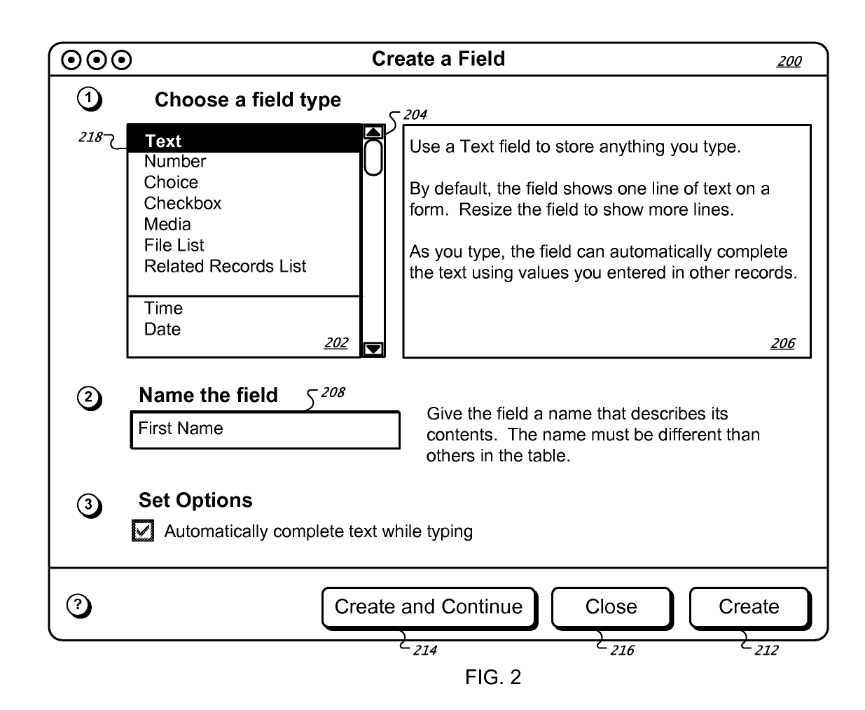

FIG. 2 is a screenshot 200 of an implementation of a GUI for creating a field within a database table. The table, for example, may be a blank table created using the GUI represented by the screenshot 100 (as described in FIG. 1). The user is presented with a selection box 202 containing types of database fields. In some implementations, the field types visible within the selection box 202 as displayed within the screenshot 200 represent single entity fields. In other implementations, both single entity fields and compound fields can be available to the user within the selection box 202 (e.g., using a scroll bar 204). Any number of field types can be available for selection within the selection box 202. An information box 206 provides the user with a description of the field type presently highlighted within the selection box 202. For example, the information box 204 describes a text field type 218 to the user.

Upon selecting a field type (e.g., the text field type 218) from within the selection box 202, the user can input a field name into an input box 208 (e.g., “First Name”). The field name, for example, can designate the desired use within the table for the field being created using the field type currently selected. The same field type can be selected any number of times for use within a table, each time using a different name to create the new field. For example, the text field type 218 can be selected from the selection box 202 and the field name “Last Name” entered into the input box 208 when creating a subsequent field. In other implementations, the user can create or save individual fields as custom a compound field type. For example, the single “First Name” and “Last Name” fields may be combined to create a compound field named “Full Name,” which could be presented in the selection box 202.

Selection of a create button 212 adds the field to the current table. In some implementations, the create button 212 also closes the GUI session represented within the screenshot 200. A create and continue button 214 may be selected when the user wishes to continue creating additional fields within the GUI. For example, after creating the “First Name” field by selecting the create and continue button 214 with the options presented within the screenshot 200, the user could create a “Last Name” field by selecting the text field type 218 from the selection box 202, entering “Last Name” into the input box 208, and selecting either the create and continue button 214 or the create button 212. A close button 216, when selected, allows the user to exit the GUI without creating a new field.

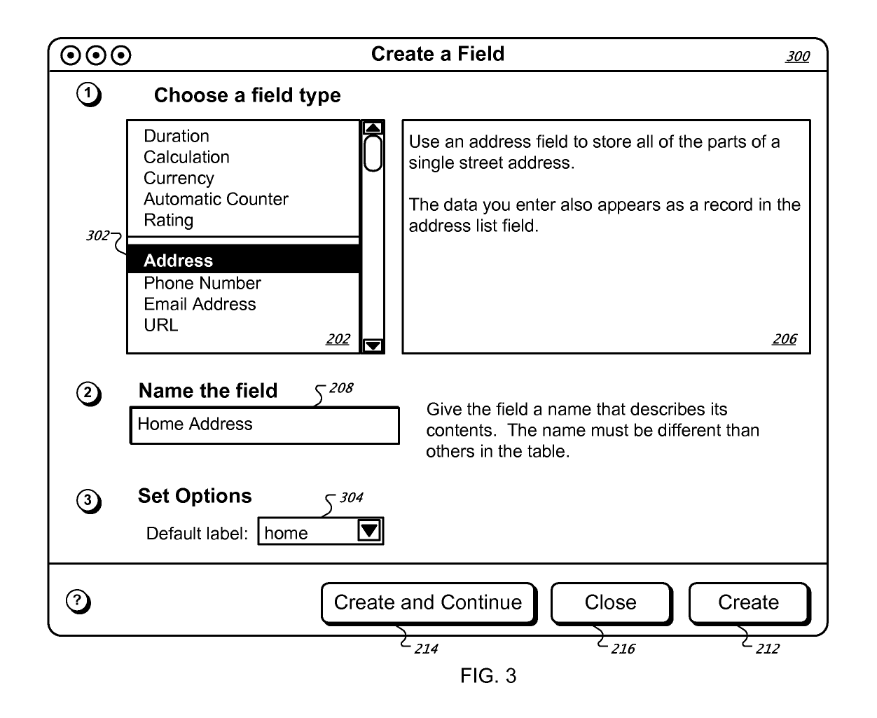

FIG. 3 is a screenshot 300 of an implementation of a GUI for creating a compound field within a database table. The table, for example, may be a blank table created within the screenshot 100 (as described in FIG. 1). Within the selection box 202, an address field type 302 is selected. The address field type 302, for example, can be a compound field including subfields related to a mailing address such as street address, city, county, province, state, zip code, country, etc.

The information box 206 informs the user that the address field can be used to store all of the parts of a single street address. The information box 206 further instructs the user that the data entered within an address field can also appear as a record in the address list field. In some implementations, when an address compound field is created, an address list field is also created which tracks all of the addresses associated with a single record within a list. For example, the records associated with “Kevin Berkley” could include both a “work address” compound field and a “home address” compound field. The address list can associate both the “work address” and the “home address” records with the “Kevin Berkley” record. The creation of a “List” field type is a general implementation mechanism, which can be applied to any other compound field type, if desired (e.g., Patient List, Employee List, etc.).

The name “Home Address” is entered within the input box 208. In addition to naming the compound field, the user has the option, within a drop-down box 304, to select a default label for the field being created. In some implementations, the default label provides the user with the ability to specify a manner in which the compound field is labeled when being presented (e.g., within a presentation screen, report, data entry screen, etc.). For example, the default label “home” can be presented alongside the collection of subfields belonging to the address compound field named “Home Address”. Other default labels, for example, can include “work”, “business”, “mailing”, “alternate”, etc. In some implementations, rather than using the drop-down box 304, the user can type in a default label. In other implementations, the name entered into the input box 208 can be used for labeling purposes.

The compound field is automatically and transparently (transparent to the user) created when the user selects the create button 212 or the create and continue button 214. The user also has the option of selecting the close button 216 to exit the GUI represented by the screenshot 300 without creating a new field.

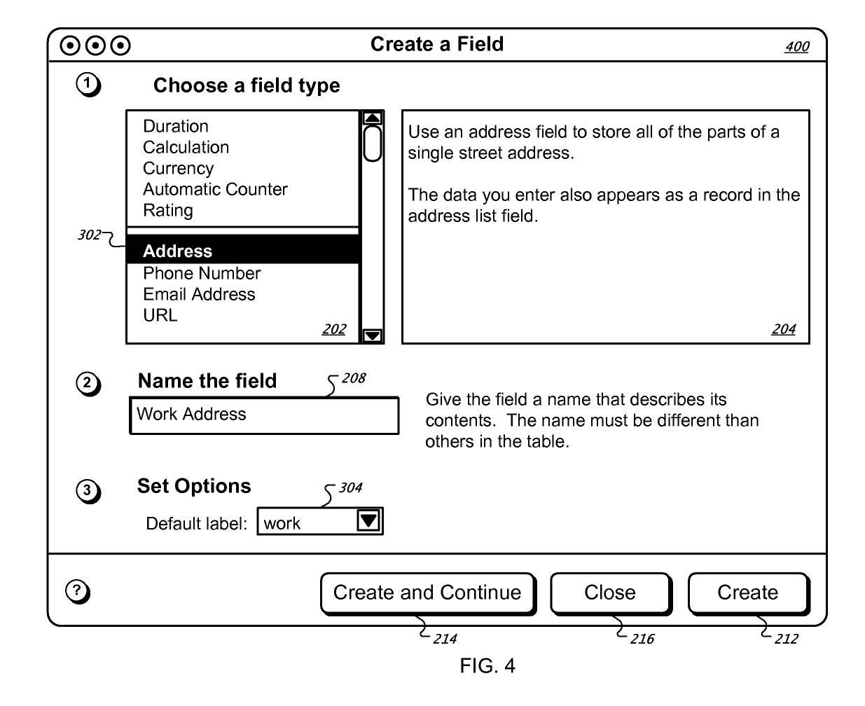

FIG. 4 is a screenshot 400 of an implementation of a GUI for creating an additional compound field of the same type within a database table. The screenshot 400, for example, may represent a continuation of the GUI session entered into within the screenshot 300 (FIG. 3). For example, if the user selected the create and continue button 214 within the screenshot 300, the user could continue to create fields within the present database table.

Within the selection box 202, the address field type 302 is selected. The name “Work Address” is entered into the input box 208. Within the drop-down box 304, the default label “work” has been selected. Within the current database table, upon creation of the field associated with the options presented within the screenshot 400, the records may contain both a home address compound field and a work address compound field. The two compound fields may additionally, in some implementations, be associated with an address list for each record (e.g. as described within the information box 206).

The compound field “Work Address” is created when the user selects the create button 212 or the create and continue button 214. The user also has the option of selecting the close button 216 to exit the GUI without creating a new field.

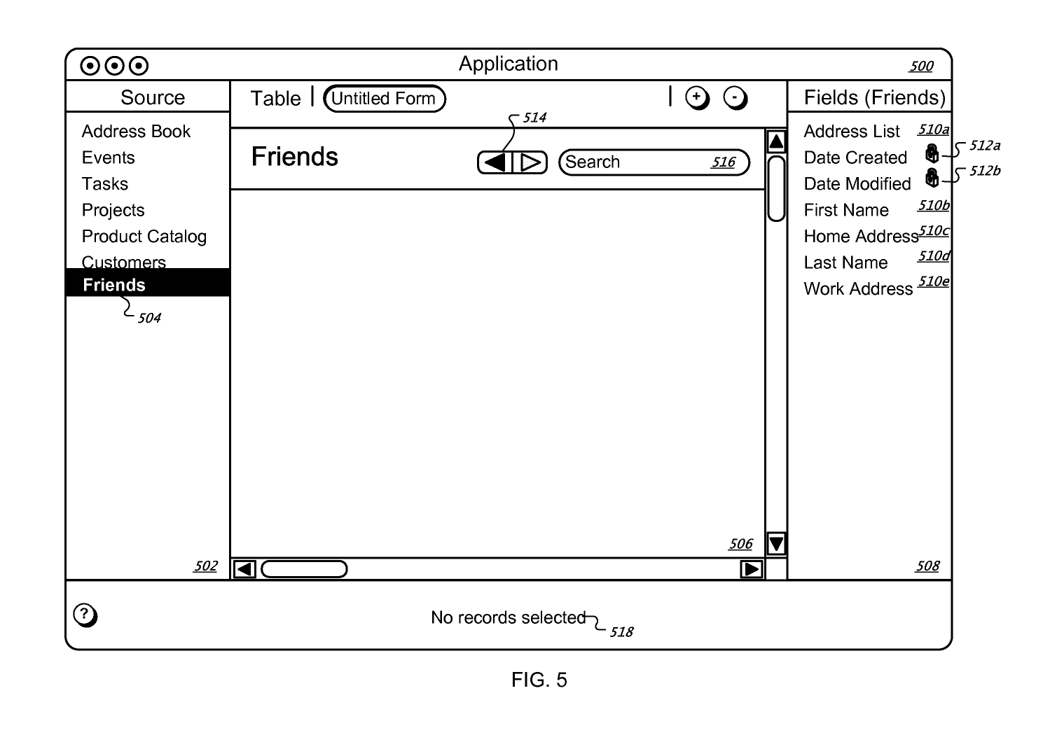

FIG. 5 is a screenshot 500 of an implementation of a GUI for adding fields to a data entry form. The data entry form, for example, can be associated with a database management system. A source pane 502 contains a list of sources. Each source, for example, can refer to a database table (e.g., address book, events, tasks, projects, product catalog, customers, and friends). In some implementations, one of more of the sources available within the source pane 502 may have been created using the GUI presented within the screenshot 100 for creating a database table (as described in FIG. 1).

A friends source 504 has been selected from within the source pane 502. A presentation pane 506, labeled “Friends”, can be populated with fields selected from a fields pane 508. The fields available within the fields pane 508 include an address list field 510a, a first name field 510b, a home address field 510c, a last name field 510d, and a work address field 510e. The fields 510, for example, may have been added to the friends source 504 using the screenshots 200, 300, 400 (FIG. 2-4). The fields pane 508 also includes two protected fields 512, a date created field 512a and a date modified field 512b. The protected fields 512 are denoted by lock icons. The protected fields 512, for example, are protected from user modification.

The fields 510 were created by the user, and can be modified and/or added to the data entry form. By dragging and dropping the fields 510 into the presentation pane 506, for example, the user can gain access to editing data in the fields 510. A set of directional arrows 514, when selected, can allow the user to navigate through the records. A search window 516 can allow the user to search through the records associated with the selected fields 510. An information region 518 provides the user with the total number of records available within the presentation pane 506 (e.g., the total number of records associated with the selected fields 510, 512 or the total number of records returned in response to a search query submitted to the search box 516, etc.). For example, the information region 518 reads “no records selected” because no fields have been added to the form, and no data has been entered in presentation pane 506 yet. The user can select a close button 520 to exit the screenshot 500.

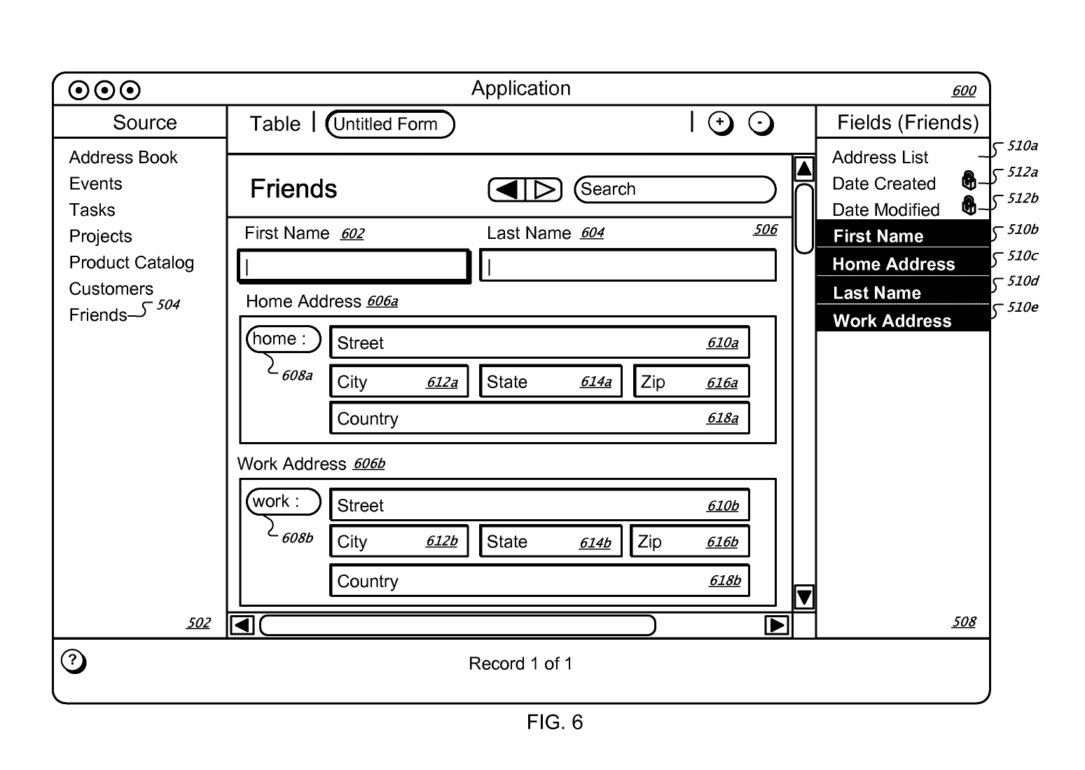

FIG. 6 is a screenshot 600 of an implementation of a GUI displaying a data entry form populated with fields. The screenshot 600 is labeled “Friends” within the presentation pane 506. For example, the friends source 504 (e.g., database table) may have been selected from the source pane 502. The fields populating the presentation pane 506, for example, may have been added by the user through dragging and dropping the first name field 510b, the home address field 510c, the last name field 510d, and the work address field 510e from the fields pane 508 into the presentation pane 506.

A first name text box 602 (e.g., associated with the first name field 510b) and a last name text box 604 (e.g., associated with the last name field 510d) are user-selectable within the presentation pane 506 for user data entry. The first name text box 602 and the last name text box 604 are single fields. Beneath the first name text box 602 and the last name text box 604 are a home address information region 606a followed by a work address information region 606b. The address information regions 606, for example, relate to the compound fields home address 510c and work address 510e. Within the address information regions 606 are a street address text box 610, a city text box 612, a state text box 614, a zip code text box 616 and a country text box 618. The address information regions are labeled by a home label 608a and a work label 608b. The user, in some implementations, can enter text within the text boxes 602, 604, 610, 612, 614, 616, and/or 618 to describe in individual record.

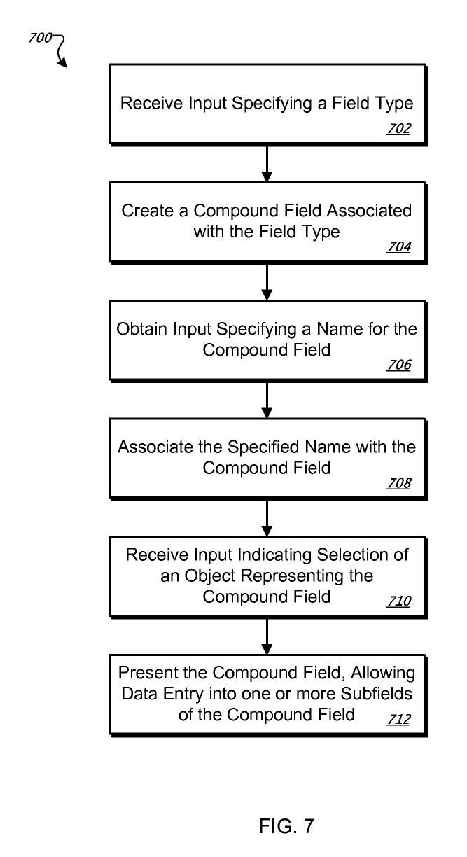

FIG. 7 is a flow diagram of an example process 700 for creating and using a compound field. The operations associated with process 700, for example, can be executed by a database application. The process 700 begins at step 702 with receiving an input specifying a field type. In some implementations, the input can be received through a field creation graphical user interface within a database application. A user could, for example, select a field type from a list of available field types. In another example, a user may create and save a custom field type to be used, for example, during record creation (e.g., as described in FIG. 2).

The field type, for example, can be a compound field type with two or more subfields associated with the field type. In step 704, a compound field is created which is associated with the field type received. For example, an employee field type could be received as an input. An employee compound field could be created containing the subfields manager, department, division, and location. In some implementations, the created field is associated with a database table.

An input is received, in step 706, specifying a name for the compound field. For example, the user could create a name for the employee compound field previously created (e.g., “trainee”, “new hire”, “full time”, “part time”, etc.). The name received is associated with the compound field in step 708. The name received refers to the collection of subfields associated with the compound field. For example, the name “new hire” refers to a field containing the subfields manager, department, division, and location. Rather than referring individually to each subfield in the future, when manipulating the records within the database table, the user only needs to refer to the name associated with the collection of subfields which belong to the compound field type employee. In some implementations, more than one compound field of a particular field type can be created within the same database table, each with a different name. For example, a name compound field type can contain the subfields title, first name, middle name, last name, and suffix. One name field could be created and named “customer” and another name field could be created and named “spouse”.

In step 710, an input is received indicating the selection of an object representing the previously created and named in steps 704 and 706, respectively. In some implementations, the selection can be made from within a graphical user interface for modifying the records associated with a database table.

In response to the selection of an object representing a compound field, in step 712 the compound field is presented. The subfields of the compound field are presented in a manner which allows data entry into one or more subfields of the compound field. For example, upon selection of the compound field “customer”, a user interface layout can be presented including data entry fields for a title, first name, middle name, last name, and suffix. In some implementations, the compound field type is associated with a display order. For example, the compound field type “address” may be presented first by street address, then city, then state, then zip code, followed by country. Additionally, address formatting could be set up to present the address within the form of the street address on a single line, followed by the city, state, and zip code on a separate line and the country within a third line.

In some implementations, the GUI as described in relation to the screenshot 300 in FIG. 3 could be used to submit the compound field creation information, while the GUI described in relation to the screenshot 600 in FIG. 6 could be used to enable data entry within the subfields of a previously created compound field. More or fewer steps can be included within process 700 depending upon the query issued. In some implementations, iterations of steps within process 700 can be executed to generate additional compound fields associated with a single record. In some implementations, one or more steps within process 700 can be executed in a different order. For example, the field type and the field name could be received together before creation of the compound field.

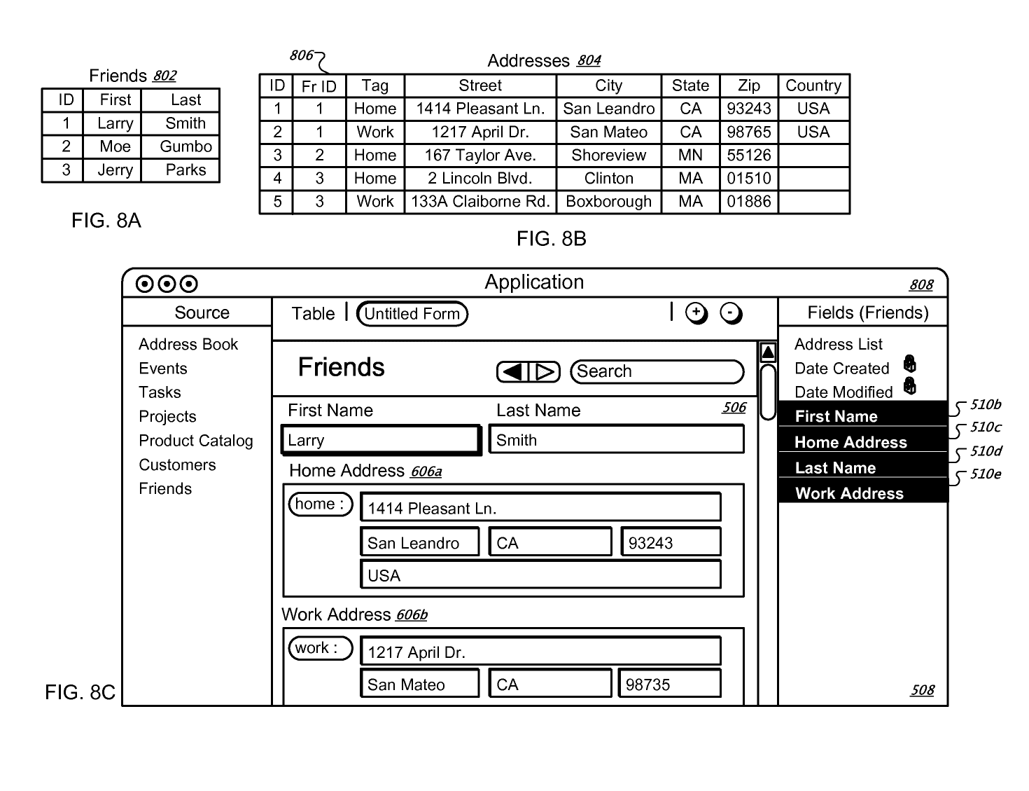

FIGS. 8A-8C illustrate generating associations between records within database tables. For example, records can be associated within the database table in a one-to-one relationship, a one-to-many relationship, or a many-to-many relationship. These associations can be used to establish compound fields. For example, in some implementations single-value compound fields (e.g., Home Address) and multi-value compound fields (e.g., Address List) can be created. For each single-value compound field a one-to-one relationship can be established between a first records table and a second records table. Similarly, for each multi-value compound field a one-to-many relationship can be established between the first records table and the second records table. Generally, for each relationship (one-to-one, one-to-many) that is created, a separate column can be created in a target table to hold the id of the parent record.

Referring to the example of FIGS. 8A-8C, records in an address records table 804 can include compound field types. For example, each address record can represent a compound address field whose subfields are stored in the street, city, state, zip code and country columns of the address records table 804. A friends id column 806, in some implementations, can be automatically added to the address records table 804 when adding more than one compound field of the same field type to a friends records table 802. For example, a first friends id column can be added to the address records table 804 when a home address field is created using a database field creation GUI (FIG. 3), and a second friends id column can be added to the address records table 804 when a work address field is created using the same GUI (FIG. 4), where both processes populate a blank table created using a table creation GUI (FIG. 1). In FIG. 8B, the address records table 804 includes a single friend id column 806, so it can represent either the Home Address relationship or the Address List relationship, but not both. To represent both relationships, a second friends id column can be added to the address records table 804 and populated with the appropriate friend id values to establish the desired relationships between records.

A screenshot 808 illustrates an example of a GUI for populating a data entry form within a database application. The screenshot 808 illustrates the data associated with the first record of the friends table 802, Larry Smith. The first name field 510b, the home address field 510c, the last name field 510d, and the work address field 510e have been selected for presentation within the presentation pane 506 (e.g., by selecting these fields 510 from within the fields pane 508). The home address information region 606a contains the address information stored within the first record of the address table 804, and the work address information region 606b contains the address information stored within the second record of the address table 804.

In some implementations, the records tables 802, 804, 806 are created using entity-relationship (ER) modeling and a physical database design. In other implementations, hierarchical modeling, relational modeling, object modeling, object-relational modeling, or another database modeling method can be used to model the information associated with the tables 802, 804, 806.

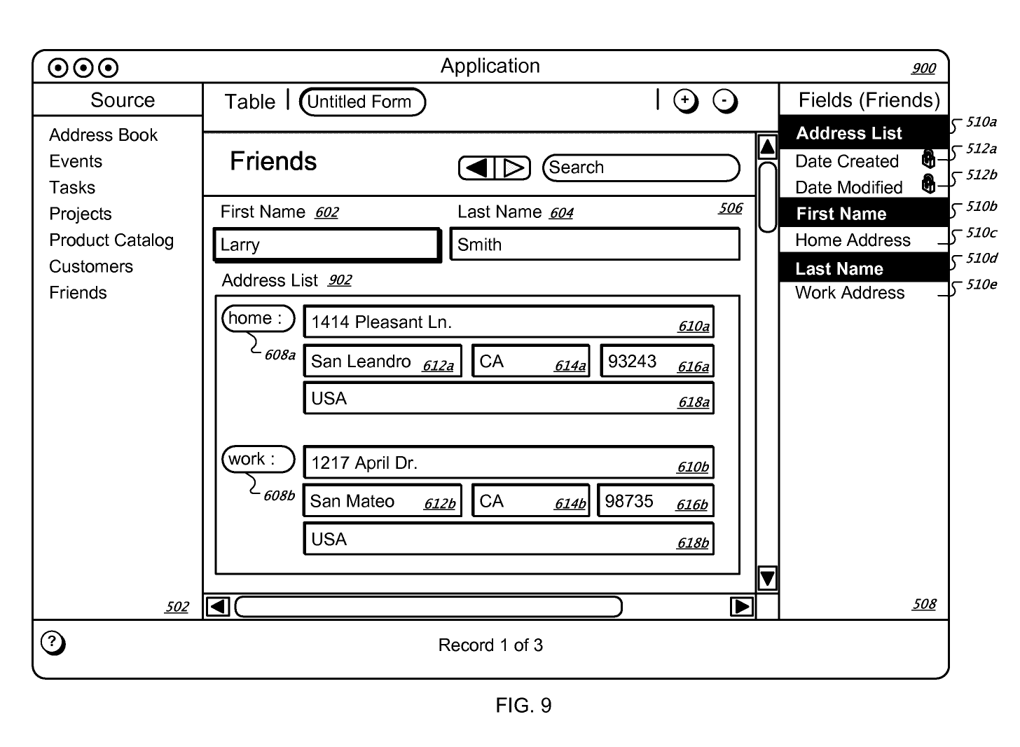

FIG. 9 is a screenshot 900 of an implementation of a GUI displaying a data entry form populated with fields. The screenshot 900, for example, contains the same fields as those presented within the screenshot 600 (FIG. 6). Rather than selecting the home address field 510c and the work address field 510e from within the field selection pane 508, for example, the user has selected the address list field 510a. Both the home address associated with the home label 608a and the work address associated with the work label 608b are presented within an address list information region 902. The address list information region 902, for example, can automatically contain all individual address records that are associated with the current friend record and are stored in the individual address fields (e.g., home address field 510c and work address field 510e) listed within the field pane 508. In some implementations, a list field can be generated after the first compound field of a particular type is created within a database table. The address list field 510a, for example, can be created when a compound address field (e.g., home address field 510c or work address field 510e) is added to a table. In some implementations, the address list field 510a corresponds to the data joined by the friends id record 806 within the address table 804 (FIG. 8).

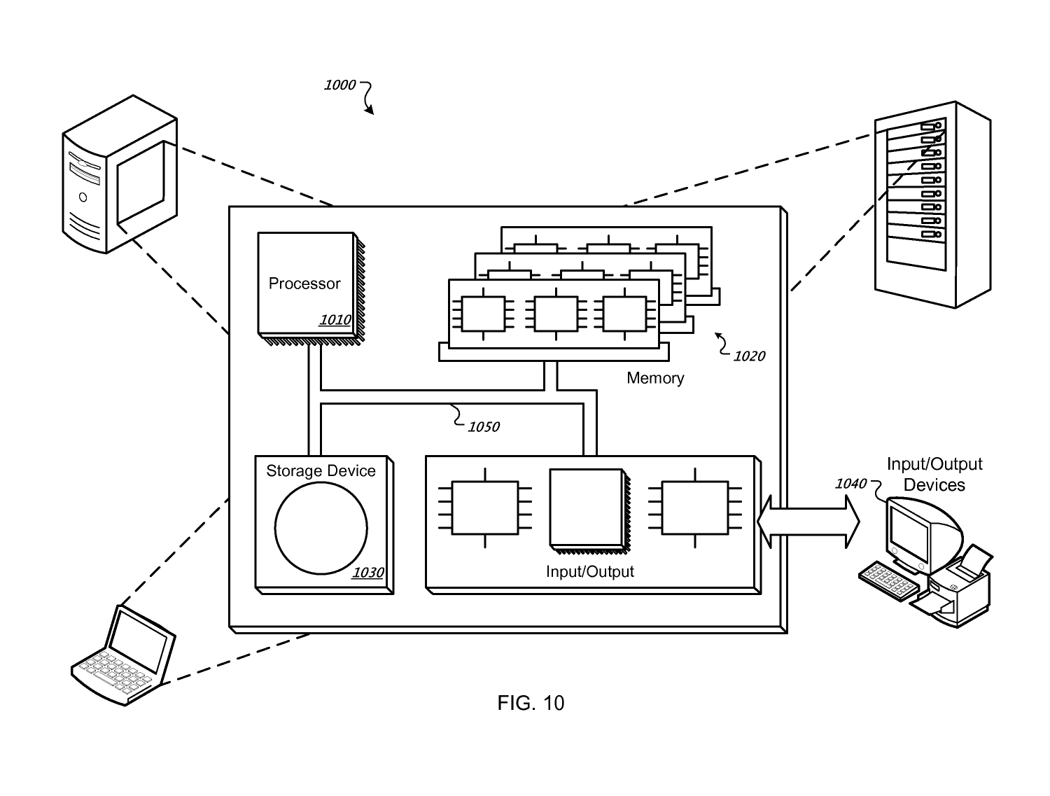

FIG. 10 is a block diagram of a system 1000 for performing the various operations described in reference to FIGS. 1-9 and 11-18. The system 1000 includes a processor 1010, a memory 1020, a storage device 1030, and an input/output device 1040. Each of the components 1010, 1020, 1030, and 1040 are interconnected using a system bus 1050. The processor 1010 is capable of processing instructions for execution within the system 1000. In some implementations, the processor 1010 is a single-threaded processor. In other implementations, the processor 1010 is a multi-threaded processor. The processor 1010 is capable of processing instructions stored in the memory 1020 or on the storage device 1030 to display graphical information for a user interface on the input/output device 1040.

The memory 1020 stores information within the system 1000. In some implementations, the memory 1020 is a computer-readable medium. In other implementations, the memory 1020 is a volatile memory unit. In yet other implementations, the memory 1020 is a non-volatile memory unit.

The storage device 1030 is capable of providing mass storage for the system 1000. In some implementations, the storage device 1030 is a computer-readable medium. In various different implementations, the storage device 1030 may be a floppy disk device, a hard disk device, an optical disk device, or a tape device.

The input/output device 1040 provides input/output operations for the system 1000. In some implementations, the input/output device 1040 includes a keyboard and/or pointing device. In other implementations, the input/output device 1040 includes a display unit for displaying graphical user interfaces.

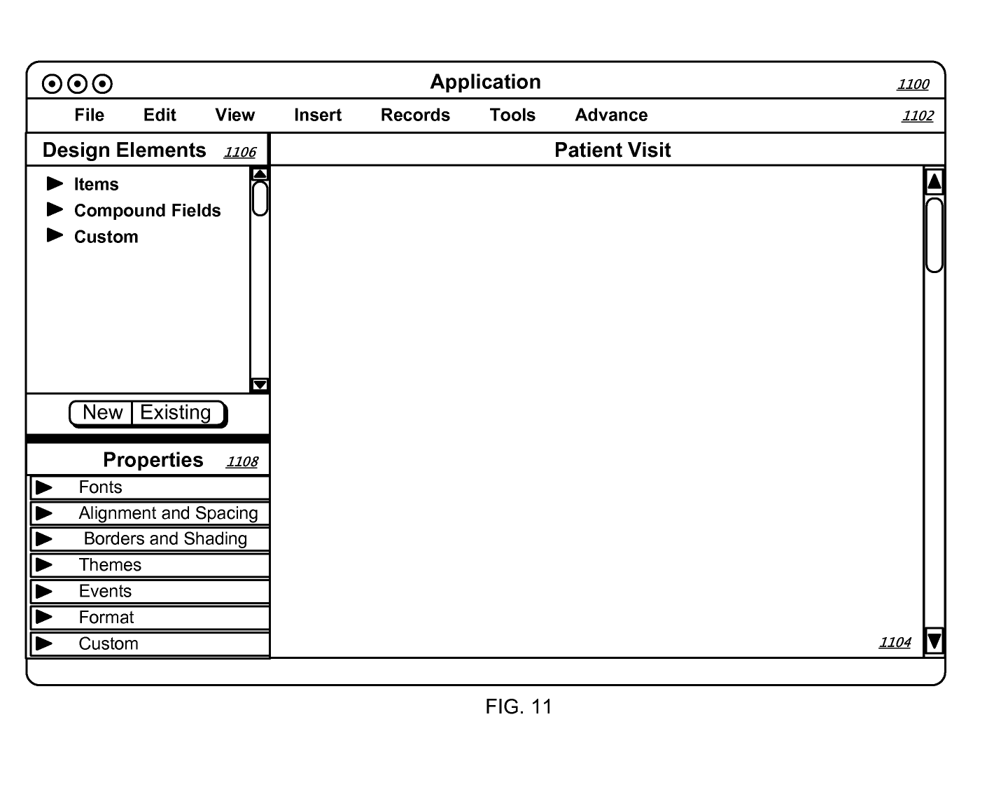

FIG. 11 is a screenshot 1100 of an example implementation of a GUI for creating and/or modifying field types within a database application. The field types, for example, can include compound fields as well as single fields. The screen shot 1100 includes a menu bar 1102, a presentation pane 1104, a design element selection box 1106, and a properties menu 1108. The menu bar 1102, for example, can provide the user with operations regarding the creation and/or modification of field types. The design element selection box 1106 contains a hierarchical listing of field types available for selection (e.g., items, compound fields, and custom). A selected field type, for example, can be presented within the presentation pane 1104 for editing purposes.

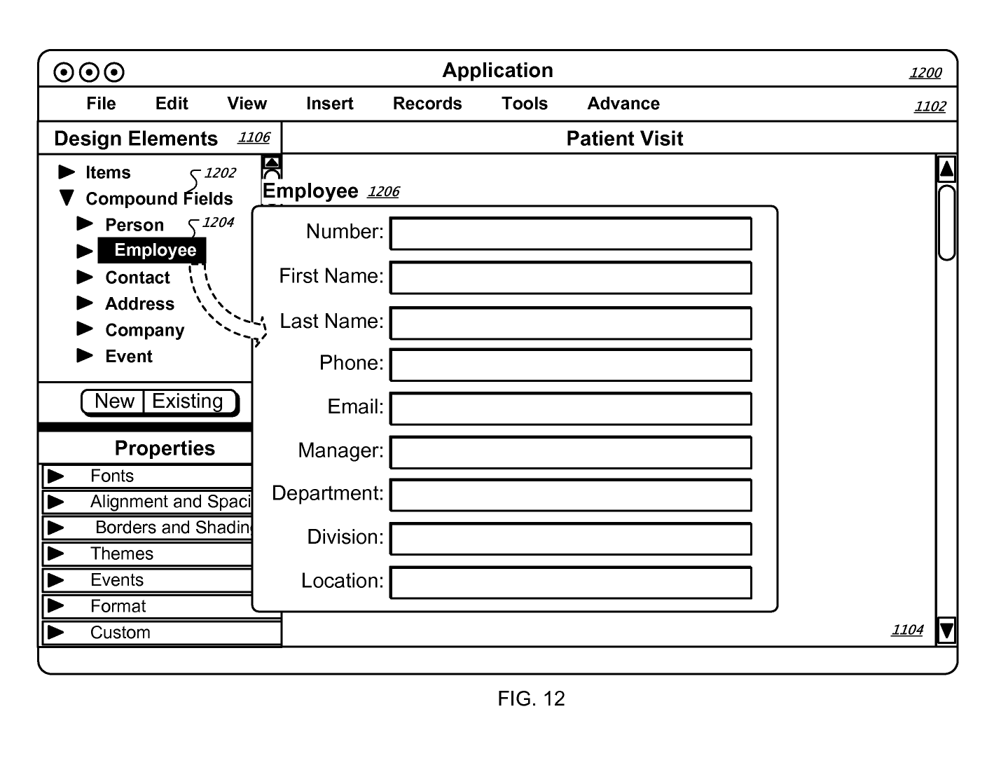

FIG. 12 is a screenshot 1200 of the GUI presented within the screenshot 1100 in which a compound fields list 1202, within the design element selection box 1106, has been expanded to expose the various field types categorized as compound fields (e.g., person, employee, contact, address, company, and event). An employee compound field 1204 has been selected.

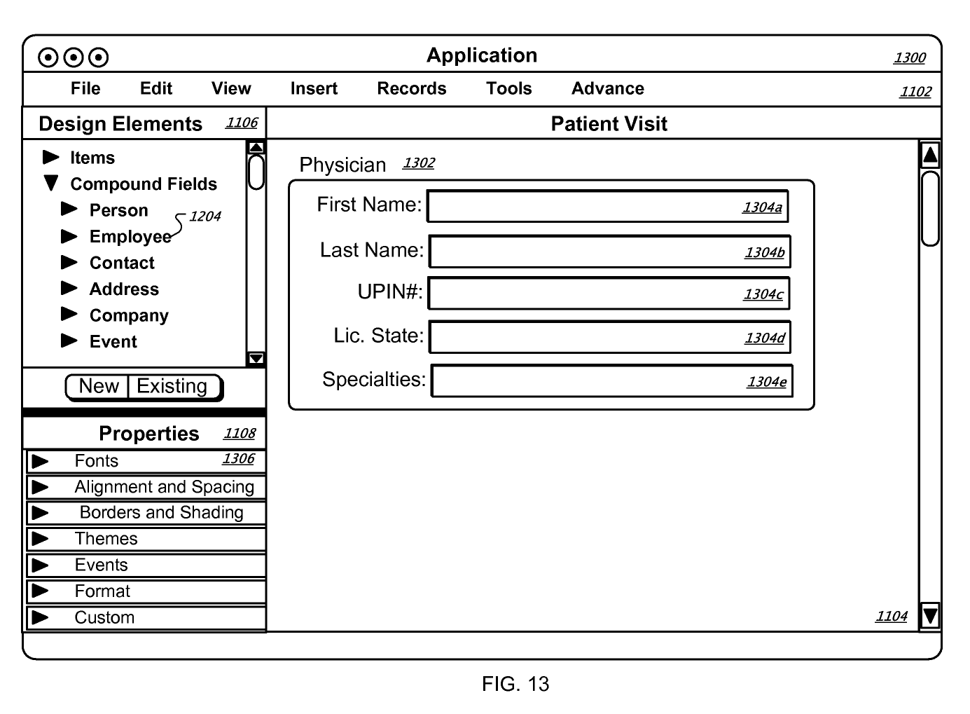

Through selection of the employee compound field 1204 (e.g., double-clicking, dragging and dropping, etc.), a screenshot 1300 within FIG. 13 illustrates an example implementation of a GUI for creating a custom compound field type within a database application. In this example, the user dragged the compound field “Employee” 1204 onto the form, viewed its subfields, modified the compound field's name from “Employee” to “Physician”, deleted several subfields and added other subfields relevant to a physician. The user then saved the remaining set of subfields as the new compound field “Physician.”.

As shown in FIG. 13, the physician field type 1302 includes a first name text box 1304a, a last name text box 1304b, a unique physician identification number (UPIN) text box 1304c, a licensing state text box 1304d, and a specialties text box 1304e. In some implementations, the physician field type 1302 is a customization of the base employee type 1204. For example, the base fields within employee type (e.g., first name, last name, employee identification number, location, and manager, etc.) could be edited to represent the field values which are specific to a physician. In addition, each field, in some implementations, can be modified to reflect the type of information associated with the customized field. For example, the UPIN field 1304c could be formatted (e.g., using options within the format menu 1306 under the properties menu 1108) to accept a 6 character alpha-numeric value.

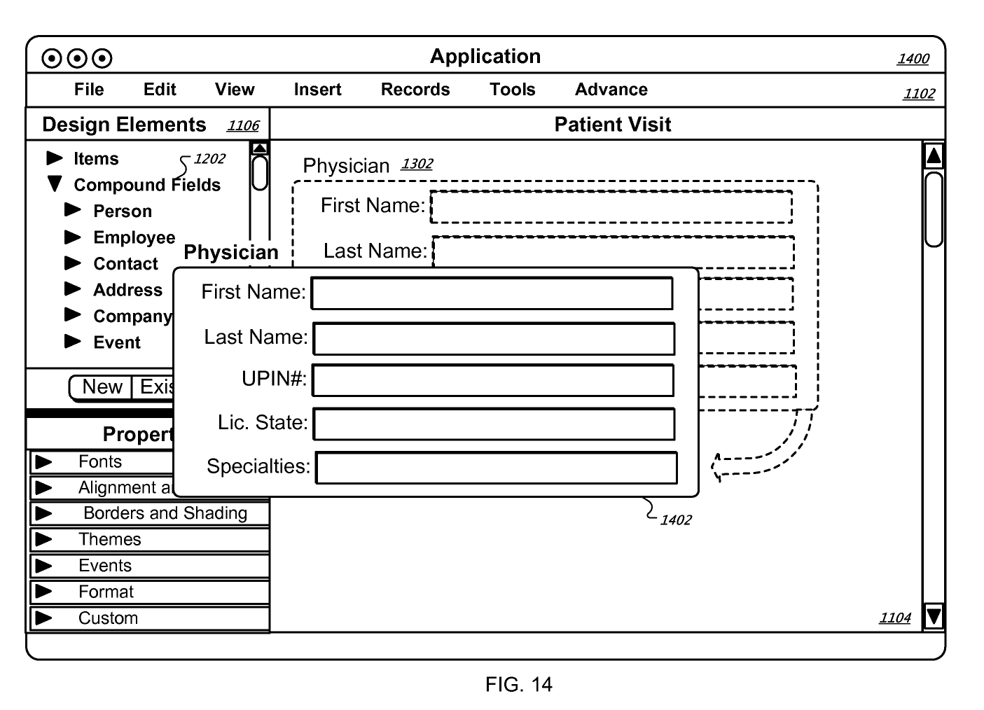

FIG. 14 is a screenshot 1400 of an example implementation of the GUI presented within the screenshot 1300 in which the physician field box 1402 is being dragged to the design element selection box 1106. In some implementations, a new field type can be created by dragging and dropping the field type into one of the menus within the design element selection box 1106. For example, the user can drag and drop the physician field box 1402 into the compound fields list 1202 to create a new compound field named “Physician.”

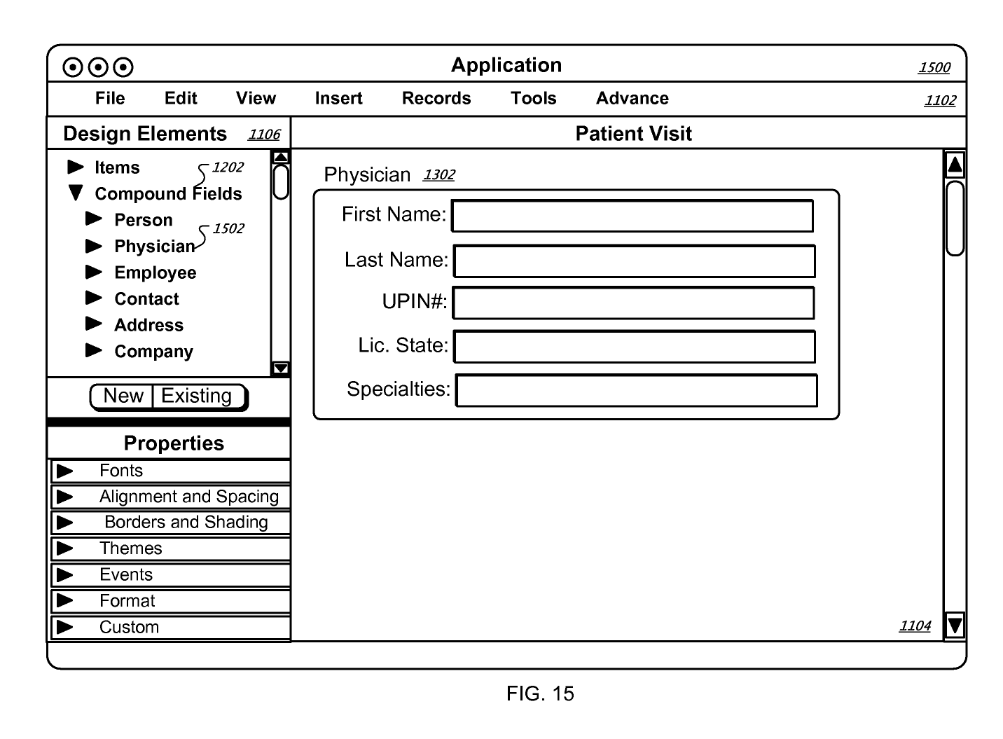

FIG. 15 is a screenshot 1500 of an example implementation of the GUI presented within the screen shot 1400 in which the physician field type 1302 has been added to the compound fields list 1202 of the design element selection box 1106. A physician element 1502 is now listed within the compound fields list 1202. The physician field type 1302 is available within the presentation pane 1104. In other implementations, dragging and dropping the physician field box 1402 into the design elements selection box 1106 can also work to close the editing session of the physician field type 1302.

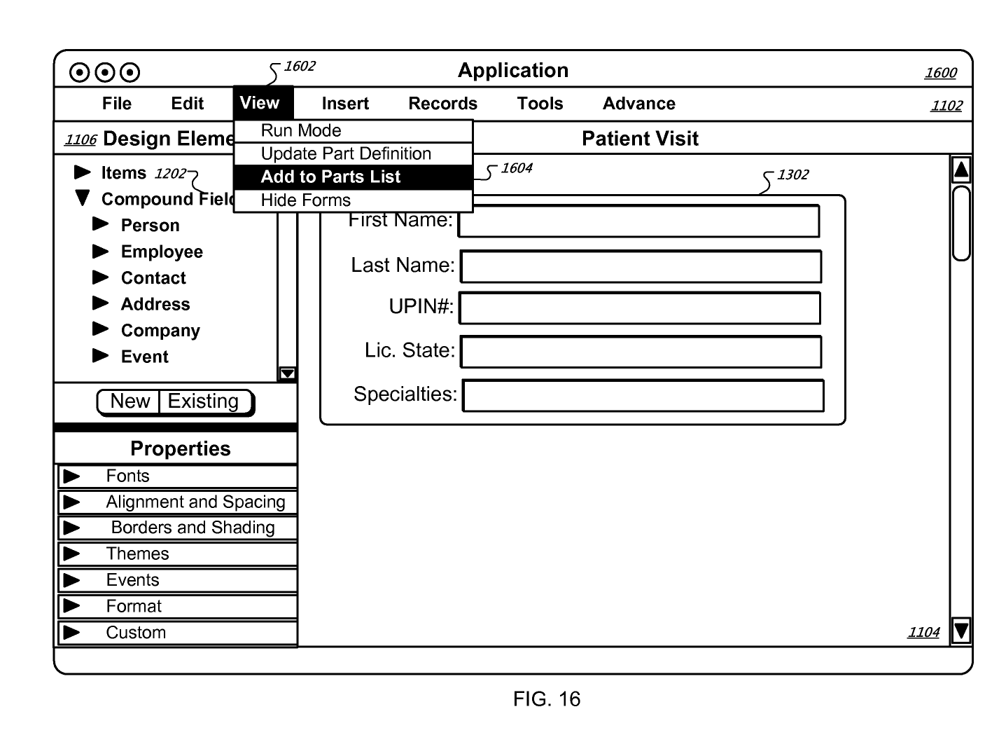

FIG. 16 is a screenshot 1600 the GUI presented within the screenshot 1300 (as described in FIG. 13) in which the physician field type 1302 is being saved to the compound fields list 1202 as a new compound field. Rather than using the dragging and dropping method described within FIG. 14, the physician field type 1302 can be saved to the compound fields list 1202 by selecting an add to parts list option 1604 from within a view menu 1602, available within the menu bar 1102. Once the physician field type 1302 has been saved, for example, the physician element 1502 (as shown in FIG. 15) may be included within the compound fields list 1202.

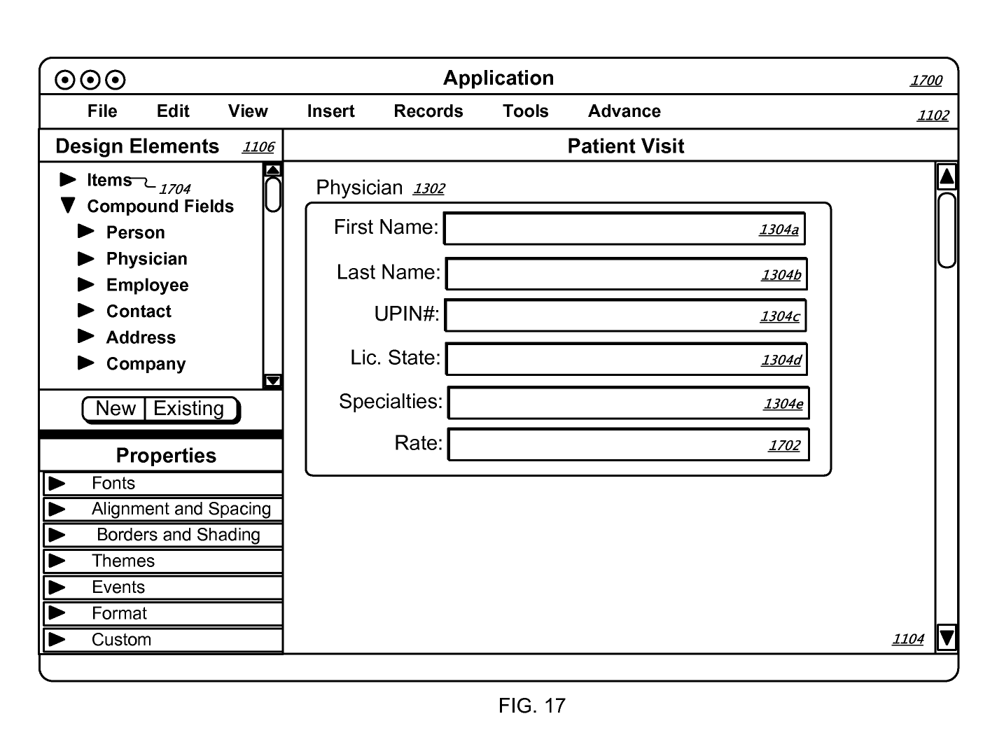

FIG. 17 is a screenshot 1700 of an example implementation of the GUI presented within the screenshot 1500 (as shown in FIG. 15) for modifying the physician field type 1302. A rate text box 1702 has been added to the physician field type 1302. The rate text box 1702, for example, may accept a dollar amount referencing the hourly rate charged by a physician. In some implementations, the rate text box 1702 could be added by dragging and dropping a basic field type (e.g., numeric, dollar, etc.) from an items list 1704 within the design elements selection box 1106.

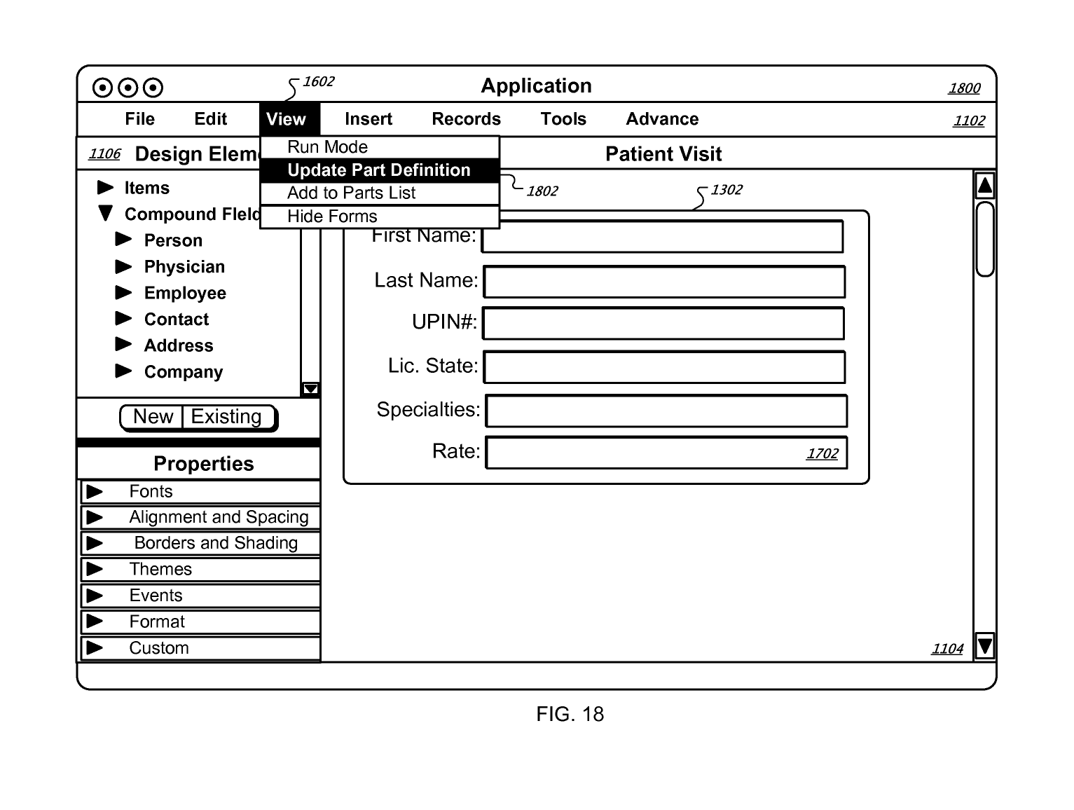

FIG. 18 is a screenshot 1800 of an example implementation of the GUI presented within the screenshot 1700 (FIG. 17) in which the modified physician field type 1302 is being saved. A view menu 1602 has been selected from within the menu bar 1102. An update part definition option 1802 is highlighted. Upon selection of the update part definition command 1802, for example, the version of the physician field type 1302 in which the rate subfield 1702 has been added can be saved to the physician element 1502.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
obtaining user input specifying a field type; and
automatically creating a compound field associated with the field type.

2. The method of claim 1, further comprising:
obtaining user input specifying a name for the compound field type; and
automatically associating the name with the field type.

3. The method of claim 1, further comprising:
obtaining input indicating a selection of an object representing the compound field in a user interface; and
responsive to the input, automatically presenting the compound field in the user interface to allow a user to enter data into one or more subfields of the compound field or to modify the subfields.

4. The method of claim 1, further comprising:
obtaining input indicating a selection of an object representing the compound field and at least one other compound field in a user interface; and
responsive to the input, automatically presenting the compound field and the at least one other compound field as a single unit in the user interface to allow a user to enter data into one or more subfields of the compound field and the at least one other compound field.

5. The method of claim 1, where creating a compound field further comprises:
creating a field in a table for each record for storing information relating records from the first set of records with records from the second set of records.

6. A system comprising:
a processor;
memory coupled to the processor and operable for storing instructions, which, when executed by the processor, causes the processor to perform operations comprising:
obtaining user input specifying a field type; and
automatically creating a compound field associated with the field type.

7. The system of claim 6, further comprising:
obtaining user input specifying a name for the compound field type; and
automatically associating the name with the field type.

8. The system of claim 6, further comprising:
obtaining input indicating a selection of an object representing the compound field in a user interface; and
responsive to the input, automatically presenting the compound field in the user interface to allow a user to enter data into one or more subfields of the compound field or to modify the subfields.

9. The system of claim 6, further comprising:
obtaining input indicating a selection of an object representing the compound field and at least one other compound field in a user interface; and
responsive to the input, automatically presenting the compound field and the at least one other compound field as a single unit in the user interface to allow a user to enter data into one or more subfields of the compound field and the at least one other compound field or to modify the subfields.

10. The system of claim 6, where creating a compound field further comprises:
creating a field in the table for each record for storing information relating records from the first set of records with records from the second set of records.

11. A computer-readable medium having instructions stored thereon, which, when executed by a processor, causes the processor to perform operations comprising:
obtaining user input specifying a field type; and
automatically creating a compound field associated with the field type.

12. The computer-readable medium of claim 11, further comprising:
obtaining user input specifying a name for the compound field type; and
automatically associating the name with the field type.

13. The computer-readable medium of claim 11, further comprising:
obtaining input indicating a selection of an object representing the compound field in a user interface; and
responsive to the input, automatically presenting the compound field in the user interface to allow a user to enter data into one or more subfields of the compound field or to modify the subfields.

14. The computer-readable medium of claim 11, further comprising:
obtaining input indicating a selection of an object representing the compound field and at least one other compound field in a user interface; and
responsive to the input, automatically presenting the compound field and the at least one other compound field as a single unit in the user interface to allow a user to enter data into one or more subfields of the compound field and the at least one other compound field or to modify the subfields.

15. The computer-readable medium of claim 11, where creating a compound field further comprises:
creating a field in the table for each record for storing information relating records from the first set of records with records from the second set of records.

16. A method comprising:
obtaining first user input specifying a field type;
automatically creating a compound field associated with the field type; and
obtaining second user input modifying the compound field type.

17. The method of claim 16, further comprising:
providing a list of predefined design elements operable by a user for modifying the compound field type.
